(19) United States
(12) Patent Application Publication
(10) Pub. No.: US 2024/0409157 A1
(43) Pub. Date: Dec. 12, 2024

(54) STEERING SAFETY SYSTEMS AND METHODS

(71) Applicant: TuSimple, Inc., SAN DIEGO, CA (US)

(72) Inventors: Joycer Damian OSORIO RODRIGUEZ, Marana, AZ (US); Yu-Ju HSU, Tucson, AZ (US)

(21) Appl. No.: 18/734,160

(22) Filed: Jun. 5, 2024

Related U.S. Application Data
(60) Provisional application No. 63/506,406, filed on Jun. 6, 2023.

(51) Int. Cl. B62D 6/02; B62D 6/00

(52) U.S. Cl. CPC B62D 6/02; B62D 6/002

(57) ABSTRACT

Improvements to steering functionality and safety thereof for a vehicle are disclosed. In particular, disclosed embodiments monitor and diagnose steering commands received by an in-vehicle controller from a remote server. The steering commands may be evaluated with respect to rationality and context. For example, a steering angle indicated by the steering command is compared to a current vehicle steering angle and/or to other steering angles indicated by preceding and/or subsequent steering commands. Based on diagnosis of the steering commands, an in-vehicle controller can permit or prevent engagement of autonomous vehicle operation, which applies the steering commands. In an autonomous mode, invalid steering commands can trigger a minimal risk condition (MRC) maneuver for the vehicle.

### CROSS-REFERENCE TO RELATED APPLICATIONS

This patent document claims priority to and the benefit of U.S. Provisional Application No. 63/506,406, filed on Jun. 6, 2023. The aforementioned application is incorporated herein by reference in its entirety.

### TECHNICAL FIELD

This document relates to steering handling and operation for an autonomous vehicle.

### BACKGROUND

Steering is a core functionality in vehicle operation and enables an operator to control a direction of travel for a vehicle. Faults and errors relating to steering can detrimentally affect vehicle operation.

### SUMMARY

This patent document discloses example embodiments for monitoring of steering operation for an autonomous vehicle. In particular, example embodiments disclosed herein involve evaluations of a rationality of steering commands that a vehicle receives from a remote server, and autonomous operation engagement of the vehicle is permitted or prevented based on the evaluations. In some embodiments, the rationality evaluations include a gap-based evaluation in which a steering command is compared against a current vehicle steering angle, and a rate-based evaluation in which a steering command is compared against previously-received steering commands. Thresholds used in each evaluation may be dependent on current vehicle speed.

In one exemplary aspect of the present disclosure, a method of monitoring steering operation of a vehicle is disclosed. The method includes receiving a steering command that indicates a steering angle for navigation of the vehicle. The method further includes performing a gap-based rationality evaluation and a rate-based rationality evaluation on the steering angle indicated by the steering command. The gap-based rationality evaluation compares a difference between the steering angle and a current vehicle steering angle against a first speed-dependent threshold, and the rate-based rationality evaluation compares a rate of change of the steering angle with one or more preceding steering commands against a second speed-dependent threshold. The method further includes determining whether the steering command is valid or not based on weighing respective flags set by the gap-based rationality evaluation and the rate-based rationality evaluation according to a current operation mode of the vehicle. The method further includes, in accordance with the current operation mode being a manual operation mode and a determination that the steering command is not valid, transmitting instructions to an in-vehicle user interface to cause the in-vehicle user interface to disable engagement of an autonomous operation mode for the vehicle via the in-vehicle user interface.

In another exemplary aspect, an in-vehicle controller for an autonomous vehicle is disclosed. The in-vehicle controller includes a processor and a memory storing executable code configured to cause the in-vehicle controller to receive, from a remote server, a steering command that indicates a steering angle for navigation of the vehicle. The executable code is further configured to cause the in-vehicle controller to perform a gap-based rationality evaluation and a rate-based rationality evaluation on the steering angle indicated by the steering command. The gap-based rationality evaluation compares a difference between the steering angle and a current vehicle steering angle against a first speed-dependent threshold, and the rate-based rationality evaluation compares a rate of change of the steering angle with one or more preceding steering commands against a second speed-dependent threshold. The executable code is further configured to cause the in-vehicle controller to determine whether the steering command is valid or not based on weighing respective flags set by the gap-based rationality evaluation and the rate-based rationality evaluation according to a current operation mode of the vehicle. The executable code is further configured to cause the in-vehicle controller to, in accordance with the current operation mode being a manual operation mode and a determination that the steering command is not valid, transmit instructions to an in-vehicle user interface to cause the in-vehicle user interface to disable engagement of an autonomous operation mode for the vehicle via the in-vehicle user interface.

In yet another exemplary aspect, an autonomous truck is disclosed. The autonomous truck includes a steering subsystem configured to orient one or more wheels of the autonomous truck to cause the autonomous truck to travel in a particular direction. The autonomous truck further includes an in-vehicle controller. The in-vehicle controller is configured to receive, from a remote server, a steering command that indicates a steering angle for navigation of the vehicle. The in-vehicle controller is further configured to perform a gap-based rationality evaluation and a rate-based rationality evaluation on the steering angle indicated by the steering command. The gap-based rationality evaluation compares a difference between the steering angle and a current vehicle steering angle against a first speed-dependent threshold, and the rate-based rationality evaluation compares a rate of change of the steering angle with one or more preceding steering commands against a second speed-dependent threshold. The in-vehicle controller is further configured to determine whether the steering command is valid or not based on weighing respective flags set by the gap-based rationality evaluation and the rate-based rationality evaluation according to a current operation mode of the vehicle. The in-vehicle controller is further configured to, in accordance with the current operation mode being a manual operation mode and a determination that the steering command is not valid, transmit instructions to an in-vehicle user interface to cause the in-vehicle user interface to disable engagement of an autonomous operation mode for the vehicle via the in-vehicle user interface.

In yet another exemplary aspect, a remote server for autonomously operating a vehicle is disclosed. The remote server is configured to receive, from an in-vehicle controller located in the vehicle, vehicle telemetry data that includes a current vehicle speed. The remote server is further configured to determine a steering command for navigation of the vehicle in accordance with a planned route of the vehicle. The steering command is determined to comply with a steering angle threshold that is based on the current vehicle speed. The remote server is further configured to, in response to transmitting the steering command to the in-vehicle controller, receive an error response that indicates that the steering command fails one or more rationality evaluations in which the steering command is compared to a current vehicle steering angle and/or one or more preceding steering commands. The remote server is further configured to reconfigure the steering command according to the error response.

In yet another exemplary aspect, the methods described herein are embodied in the form of processor-executable code and stored in a non-transitory computer-readable storage medium. The code included in the computer readable storage medium when executed by a processor, causes the processor to implement the methods described in this patent document.

In yet another exemplary embodiment, a device, system, or apparatus that is configured or operable to perform the methods described herein is disclosed.

The above and other aspects and their implementations are described in greater detail in the drawings, the descriptions, and the example claim concepts at the end of this document.

### BRIEF DESCRIPTION OF THE DRAWINGS

FIG. 1 shows a block diagram of an example vehicle ecosystem in which steering command monitoring can be implemented, in accordance with embodiments disclosed herein.

FIG. 2 shows a block diagram of an example computer configured to monitor steering commands received from a remote server, in accordance with embodiments disclosed herein.

FIG. 3 shows a block diagram of steering command communication between a remote server and components of a vehicle, in accordance with embodiments disclosed herein.

FIG. 4 shows a block diagram of example operations implemented by an in-vehicle controller device to monitor steering commands received from a remote server, in accordance with embodiments disclosed herein.

FIG. 5 shows a block diagram for an example gap-based evaluation of a steering command, in accordance with embodiments disclosed herein.

FIG. 6A shows a block diagram for an example rate-based evaluation of a steering command, in accordance with embodiments disclosed herein.

FIG. 6B illustrates an example speed-dependent threshold for a rate-based evaluation of a steering command, in accordance with embodiments disclosed herein.

FIG. 7 illustrates example speed-dependent thresholds according to operation modes of a vehicle, in accordance with embodiments disclosed herein.

FIG. 8 shows an example flow diagram for monitoring steering commands received by a vehicle from a remote server, in accordance with embodiments disclosed herein.

FIG. 9 shows a block diagram of multi-phase monitoring and arbitration of steering commands received from a remote server, in accordance with embodiments disclosed herein.

FIG. 10 illustrates example threshold data for a rate-based evaluation of a steering command, in accordance with embodiments disclosed herein.

FIG. 11 illustrates example threshold data for a gap-based evaluation of a steering command, in accordance with embodiments disclosed herein.

FIG. 12 illustrates simulated data to demonstrate a rate-based evaluation for triggering an emergency condition for a vehicle, in accordance with embodiments disclosed herein.

FIG. 13 shows a flow diagram for arbitrating or correcting steering commands received from a remote server, in accordance with embodiments disclosed herein.

### DETAILED DESCRIPTION

The disclosed technology includes gatekeepers or steering safety modules implemented at an in-vehicle control computer (e.g., a vehicle control unit, or VCU) located in an autonomous vehicle. Example steering safety modules monitor and diagnose steering commands received from a remote server and arbitrate actions to a steering subsystem of the vehicle and/or other subsystems based on the diagnosis.

Example embodiments disclosed herein address various technical challenges. First, implementation of a steering safety module locally at a vehicle represents a last line of defense against steering-related errors, faults, and attacks. That is, while a remote server itself may perform various evaluations on the steering commands that it transmits to an in-vehicle controller, communication issues and the like (e.g., spoofing, packet loss) may occur in transmission, and as a result, an in-vehicle controller may arbitrate erroneous steering commands. Therefore, example embodiments include a steering safety module at least at the in-vehicle controller so that steering command can be monitored and diagnosed immediately before being applied.

Second, example embodiments disclosed herein provide evaluations of steering commands with respect to rationality, thereby improving a complexity and comprehensiveness of steering command monitoring. In particular, example embodiments evaluate steering commands against various contexts, including a current vehicle steering angle and other steering commands. In doing so, erroneous steering commands that may pass angle-based evaluations (e.g., is the steering command angle less than a maximum angle?) are detected, and steering command monitoring and steering operation resiliency is improved. In example embodiments, rationality evaluations of steering commands are performed along with other types of evaluations (e.g., validity and angle-based evaluations) to provide a comprehensive diagnosis of steering commands.

Third, example embodiments disclosed herein rigorously monitor steering commands across different operational modes of a vehicle. According to some embodiments, an example vehicle may be operated in (i) a manual operation mode/state in which the in-vehicle controller receives commands from a remote server but does not apply the commands to vehicle subsystems in favor of inputs provided by a local operator instead (e.g., a human driver using a steering wheel), and (ii) an autonomous operation mode/state in which the in-vehicle controller applies the commands that the in-vehicle controller receives. Although steering commands are not necessarily applied in the manual operation mode/state of the vehicle, monitoring of the steering commands remains critical in order to classify a health of the vehicle so that abrupt and immediate engagement of the autonomous operation mode/state can be carried out. In example embodiments, post-evaluation actions with the steering commands depend on whether the vehicle is presently in the manual operation mode/state or the autonomous operation mode/state. Accordingly, the steering command monitoring provided by example embodiments disclosed herein includes and supports operation mode engagement and mode-specific actions for a vehicle.

At least these and other technical improvements are provided by the disclosed technology. Example embodiments disclosed herein may detect invalid and/or irrational steering commands. As illustrative examples, steering commands stuck in the same value over a certain period of time, steering commands that are too large compared to a current vehicle steering angle, steering commands that are too large at the current vehicle speed, and steering commands with values changing too fast over a certain period of time may be detected, and a vehicle may be handled accordingly with safety.

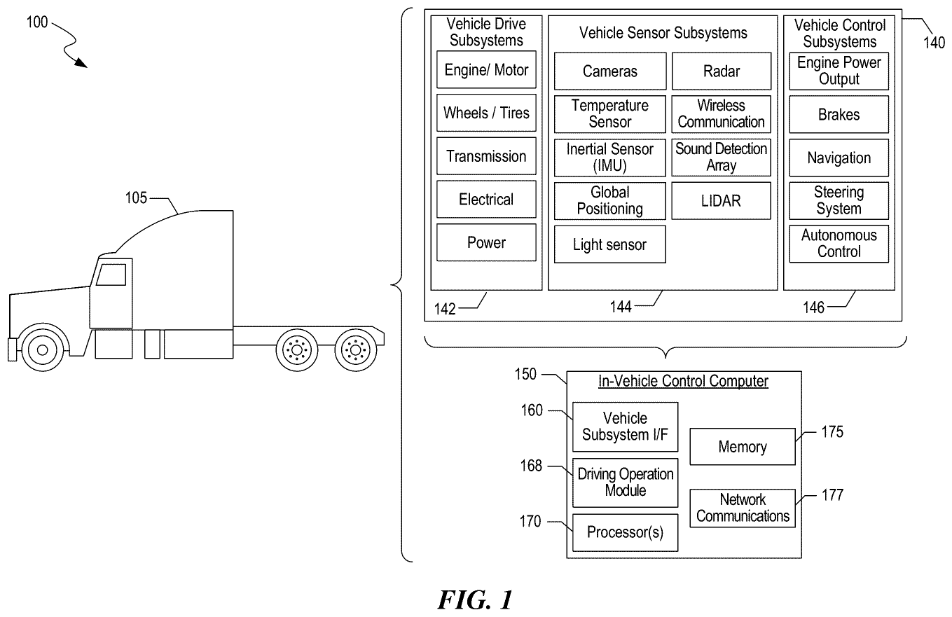

FIG. 1 shows a block diagram of an example vehicle ecosystem 100 in which example embodiments for monitoring steering commands received at an autonomous vehicle 105 from a remote server can be implemented. Examples of autonomous vehicle 105 include a car, a truck, or a semi-trailer truck. The vehicle ecosystem 100 includes several systems and subsystems that can generate and/or deliver one or more sources of information/data and related services to the in-vehicle control computer 150 that may be located in an autonomous vehicle 105. The several system and subsystems can be controlled and operated by the in-vehicle control computer 150. The in-vehicle control computer 150 can be in data communication with a plurality of vehicle subsystems 140, all of which can be resident in an autonomous vehicle 105. A vehicle subsystem interface 160 is provided to facilitate data communication between the in-vehicle control computer 150 and the plurality of vehicle subsystems 140. The vehicle subsystem interface 160 can include a wireless transceiver, a Controller Area Network (CAN) transceiver, an Ethernet transceiver, serial ports, gigabit multimedia serial link 2 (GMSL2) ports, local interconnect network (LIN) ports, or any combination thereof.

The autonomous vehicle 105 may include various vehicle subsystems that support the operation of autonomous vehicle 105 and that can be controlled or operated by the in-vehicle control computer 150, and in some embodiments, control and operator of the various vehicle subsystems by the in-vehicle control computer 150 applies commands received by the in-vehicle control computer 150 from a remote server. The vehicle subsystems may include a vehicle drive subsystem 142, a vehicle sensor subsystem 144, and/or a vehicle control subsystem 146. The vehicle drive subsystem 142 may include components operable to provide powered motion for the autonomous vehicle 105. In some embodiments, the vehicle drive subsystem 142 may include an engine or motor, wheels/tires, a transmission, an electrical subsystem, and a power source (e.g., battery and/or alternator).

The vehicle sensor subsystem 144 may include a number of sensors configured to sense information about an environment or condition of the autonomous vehicle 105. For example, the vehicle sensor subsystem 144 may include an inertial measurement unit (IMU), a Global Positioning System (GPS) transceiver, a RADAR unit, a laser range finder or a light detection and ranging (LiDAR) unit, and/or one or more cameras or image capture devices. The vehicle sensor subsystem 144 may also include sensors configured to monitor internal systems of the autonomous vehicle 105 (e.g., an O₂ monitor, a fuel gauge, an engine oil temperature). In some embodiments, the vehicle sensor subsystem 144 includes sensors configured to determine a current vehicle steering angle, such as by tracking rotational angles or revolutions of a steering column, steering wheel, and/or other components of a steering system of the autonomous vehicle 105.

In some embodiments, the vehicle sensor subsystem 144 includes sensors that collect signals from which a speed of the autonomous vehicle 105 can be determined. For example, the vehicle sensor subsystem 144 includes sensors configured to collect sensor signals describing a rotational speed of each wheel or tire of the autonomous vehicle 105, sensor signals describing an operation of the vehicle drive subsystem 142 (e.g., rotational speed of a transmission output shaft, rotational speed of engaged gears, engine or motor power consumption), and/or the like.

The IMU may include any combination of sensors (e.g., accelerometers and gyroscopes) configured to sense position and orientation changes of the autonomous vehicle 105 based on inertial acceleration. For example, the IMU is configured to collect sensor signals from which a speed of the autonomous vehicle 105 can be determined. The GPS transceiver may be any sensor configured to estimate a geographic location of the autonomous vehicle 105. For this purpose, the GPS transceiver may include a receiver/transmitter operable to provide information regarding the position of the autonomous vehicle 105 with respect to the Earth. The RADAR unit may represent a system that utilizes radio signals to sense objects within the local environment of the autonomous vehicle 105. In some embodiments, in addition to sensing the objects, the RADAR unit may additionally be configured to sense the speed and the heading of the objects proximate to the autonomous vehicle 105. The laser range finder or LIDAR unit may be any sensor configured to sense objects in the environment in which the autonomous vehicle 105 is located using lasers. The cameras may include one or more devices configured to capture a plurality of images of the environment of the autonomous vehicle 105. The cameras may be still image cameras or motion video cameras.

The vehicle control subsystem 146 may be configured to control operation of the autonomous vehicle 105 and its components. Accordingly, the vehicle control subsystem 146 may include various elements such as a steering system, a throttle, one or more brake units or subsystems, and/or a navigation unit. In some embodiments, the steering system is configured to control an orientation or direction of travel for the autonomous vehicle 105 (e.g., by orienting wheels/tires of the autonomous vehicle 105) in accordance with an input to the steering system (e.g., an electronic input from the in-vehicle control computer 150, a physical input by a human driver via a steering wheel). In some embodiments, the steering system includes one or more of a steering-box system, a bell-crank steering system, a rack-and-pinion system, a power-assisted steering system, and/or the like. In some embodiments, the steering system is configured to turn or point one, two, three, four, or more of the wheels/tires of the autonomous vehicle 105. In some embodiments, the steering system includes a steering wheel located in a cabin of the autonomous vehicle 105 via which a human operator or drive can physically actuate steering of the wheels/tires of the autonomous vehicle 105. In some embodiments, the steering system includes one or more motorized components, hydraulic components, and/or the like that are operable by the in-vehicle control computer 150 for actuating steering action.

The throttle may be configured to control, for instance, the operating speed of the engine and, in turn, control the speed of the autonomous vehicle 105. In some embodiments, the one or more brake units or subsystems include various brakes configured to slow and/or stop vehicle travel. The brake unit can include any combination of mechanisms configured to decelerate the autonomous vehicle 105. The brake unit can use friction to slow the wheels in a standard manner. For example, the brake units or subsystems may include disc or drum brakes of wheels of the autonomous vehicle 105. In particular, the brake units or subsystems includes parking brakes configured to secure a motionless or stationary state of the autonomous vehicle 105. The parking brakes may be configured for use when the autonomous vehicle is in or near a stationary state. In some embodiments, the brake units or subsystems include alternative brake units that may be operated to support the function of the parking brakes in securing a motionless state of the vehicle. For example, the alternative brake units include foundation brakes.

The navigation unit may be any system configured to determine a driving path or route for the autonomous vehicle 105. The navigation unit may additionally be configured to update the driving path dynamically while the autonomous vehicle 105 is in operation. In some embodiments, the navigation unit may be configured to incorporate data from the GPS transceiver and one or more predetermined maps so as to determine the driving path for the autonomous vehicle 105. With the navigation unit, the in-vehicle control computer 150 may be configured to locally determine steering inputs to apply to the steering system. As such, if communication between the in-vehicle control computer 150 and the remote server is lost, the in-vehicle control computer 150 may be capable of some maneuvering of the autonomous vehicle 105.

The vehicle control subsystem 146 may be configured to control operation of power distribution units located in the autonomous vehicle 105. The power distribution units have an input that is directly or indirectly electrically connected to the power source of the autonomous vehicle 105 (e.g., alternator). Each power distribution unit can have one or more electrical receptacles or one or more electrical connectors to provide power to one or more devices of the autonomous vehicle 105. For example, various sensors of the vehicle sensor subsystem 144 such as cameras and LiDAR units may receive power from one or more power distribution units. The vehicle control subsystem 146 can also include power controller units, where each power controller unit can communicate with a power distribution unit and provide information about the power distribution unit to the in-vehicle control computer 150, for example.

Many or all of the functions of the autonomous vehicle 105 can be controlled by the in-vehicle control computer 150. The in-vehicle control computer 150 may include at least one data processor 170 (which can include at least one microprocessor) that executes processing instructions stored in a non-transitory computer readable medium, such as the data storage device 175 or memory. The in-vehicle control computer 150 may also represent a plurality of computing devices that may serve to control individual components or subsystems of the autonomous vehicle 105 in a distributed fashion. The individual components or modules of the in-vehicle control computer 150 may operate and communicate together to cause the autonomous vehicle 105 to operate. The various components and modules of the in-vehicle control computer 150 can each be associated with a domain or functionality. In some examples, components or modules of the in-vehicle control computer 150 feed into and communicate with each other in a hierarchy or order. Outputs of an upstream module of the in-vehicle control computer 150 are inputs to a downstream module of the in-vehicle control computer 150.

In some embodiments, the data storage device 175 may contain processing instructions (e.g., program logic) executable by the data processor 170 to perform various methods and/or functions of the autonomous vehicle 105, including those described in this patent document. The various components and modules of the in-vehicle control computer 150 can be implemented as software modules in the processing instructions. Thus, in some embodiments, the data storage device 175 includes processing instructions for each of a plurality of modules of the in-vehicle control computer 150.

The data storage device 175 may include instructions to transmit data to, receive data from, interact with, or control one or more of the vehicle drive subsystem 142, the vehicle sensor subsystem 144, and the vehicle control subsystem 146. In some embodiment, additional components or devices can be added to the various subsystems or one or more components or devices (e.g., temperature sensor shown in FIG. 1) can be removed without affecting various embodiments described in this patent document. The in-vehicle control computer 150 can be configured to include a data processor 170 and a data storage device 175.

The in-vehicle control computer 150 may control the function of the autonomous vehicle 105 based on inputs received from various vehicle subsystems (e.g., the vehicle drive subsystem 142, the vehicle sensor subsystem 144, and the vehicle control subsystem 146). For example, the in-vehicle control computer 150 may use speed measurements from the vehicle control subsystem 146 in order to monitor steering commands and use steering commands compliant with speed-dependent thresholds to maneuver the autonomous vehicle 105. In some embodiments, the in-vehicle control computer 150 may pass data received from various vehicle subsystems, such as the vehicle sensor subsystem 144, to a remote server for the remote server to determine commands for vehicle operation.

In some embodiments, the in-vehicle control computer 150 includes a network communicator 177 which may be configured to communicate with a remote system, server, or computer located outside of the autonomous vehicle 105. In some embodiments, the remote system is an oversight system that provides operational commands to the autonomous vehicle 105, including steering commands, navigational instructions, acceleration/deceleration commands, and/or the like.

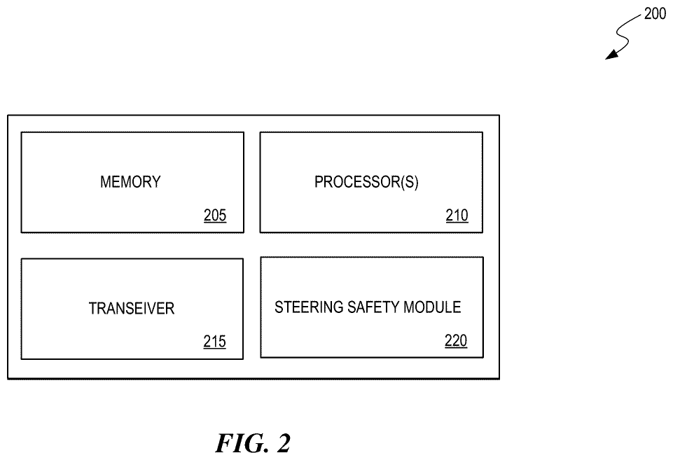

Turning now to FIG. 2, an exemplary block diagram of a computing device 200 is illustrated. The computing device 200 may be configured for safely operating a vehicle based on monitoring and diagnosing steering commands received from a remote server. In some embodiments, the computing device 200 is embodied by the in-vehicle control computer 150.

As illustrated, the computing device 200 includes at least one processor 210 and a memory 205 having instructions stored thereupon. The instructions, upon execution by the processor 210, configure the computing device 200 to perform the example operations related to performing rationality evaluations on steering commands received from a remote server that are described herein. The instructions executed by the processor 210 may be carried out by a special purpose computer, logic circuits, or hardware circuits. The processor 210 may be implemented in hardware, firmware, software, or any combination thereof. The term “execution” is, for example, the process of running an application or the carrying out of the operation called for by an instruction. The instructions may be written using one or more programming language, scripting language, assembly language, etc. By executing the instruction, the processor 210 can perform the operations called for by that instruction. The processor 210 operably couples with the memory 205 and transceiver 215 to receive, to send, and to process information and to control the operations of the computing device 200. The processor 210 may retrieve a set of instructions from a permanent memory device such as a ROM device and copy the instructions in an executable form to a temporary memory device that is generally some form of RAM. In some implementations, the computing device 200 can include a plurality of processors that use the same or a different processing technology.

The transceiver 215 transmits and receives information or data to and from other devices, such as a remote server associated with remote and autonomous operation of a vehicle. For example, the transceiver 215 sends vehicle telemetry data (e.g., heading, speed, location), receives steering commands for maneuvering the vehicle, reports instances of faulty steering commands, reports instances of autonomous mode engagement, and/or the like. The transceiver 206 may be comprised of a transmitter and a receiver; in some embodiments, the computing device 200 comprises a transmitter and a receiver that are separate from another but functionally form a transceiver.

The computing device 200 further includes a steering safety module 220. In some embodiments, the steering safety module 220 is implemented in software as executable instructions stored by the memory 205 and executed by the processor 210. In some embodiments, the steering safety module 220 is implemented as hardware components that may include respective processing units and memory units. In some embodiments, the steering safety module 220 implements operations and methods disclosed herein for monitoring steering commands for vehicle operation safety. In particular, in some embodiments, the steering safety module 220 implements operations related to performing evaluations with respect to rationality of steering commands and arbitrating mode-specific actions for vehicle operation based on the evaluations.

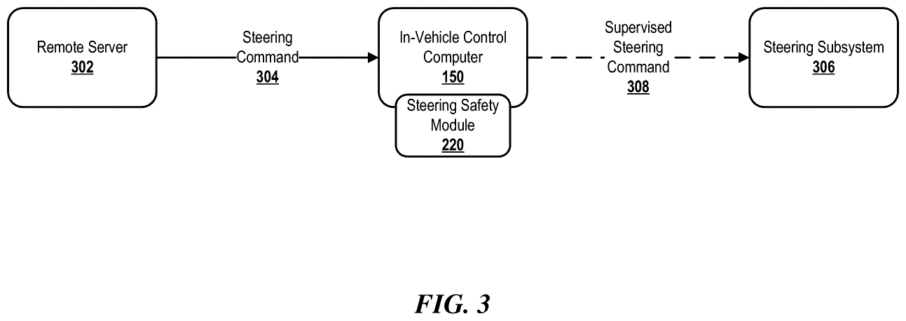

FIG. 3 illustrates a diagram that describes example operations and implementations related to the steering safety module 220. In some embodiments, the steering safety module 220 may be implemented at an in-vehicle control computer 150, and being located at the vehicle, the steering safety module 220 serves as a final check on steering commands before the steering commands are applied to maneuver a vehicle. As illustrated in FIG. 3, a remote server 302 may determine a steering command 304, for example based on a route planned for the vehicle and/or based on any obstacles detected by the vehicle and indicated to the remote server 302, and the remote server 302 may transmit the steering command 304 to the in-vehicle control computer 150. In some embodiments, the remote server 302 implements various preliminary evaluations and checks on the steering command 304 before transmitting the steering command 304 to the in-vehicle control computer 150.

The in-vehicle control computer 150 may then receive the steering command 304, and with the steering safety module 220, the in-vehicle control computer 150 evaluates the steering command 304, at least with respect to rationality. In accordance with embodiments disclosed herein, the in-vehicle control computer 150 may perform a gap-based evaluation and a rate-based evaluation on the steering command 304, for example. Via the evaluation(s) of the steering command 304, the in-vehicle control computer 150 may determine that the steering command 304 is valid or not.

With a determination that the steering command 304 is valid, the in-vehicle control computer 150 may apply the steering command 304 based on controlling a steering subsystem 306 (e.g., a component of the vehicle control subsystems 146). In the illustrated example, the in-vehicle control computer 150 passes a supervised steering command 308 to the steering subsystem 306. In some examples, the supervised steering command 308 is the steering command 304 as approved/validated by the steering safety module 220. In some examples, the supervised steering command 308 is a modification of the steering command 304 by the steering safety module 220 so that the supervised steering command 308 complies with speed-dependent thresholds.

In some embodiments, the in-vehicle control computer 150 may determine that the steering command 304 is not valid, and the in-vehicle control computer 150 may transmit an indication of the invalidity of the steering command to the remote server 302. In some embodiments, the in-vehicle control computer 150 may indicate a specific reason why the in-vehicle control computer 150 determined that the steering command is invalid, for example, by including a current vehicle steering angle and/or a determined rate of change between the steering command and previous steering commands. In some embodiments, the remote server 302 is configured to reconfigure a steering command 304 subsequent to receiving an error response from the in-vehicle control computer 150. In some embodiments, the error response includes various thresholds and data used by the steering safety module 220 (e.g., current vehicle speed and current steering angle), and the remote server 302 is configured to use the thresholds and data to reconfigure the steering command 304.

As indicated by the FIG. 3, the in-vehicle control computer 150 may not transmit the supervised steering command 308 to the steering subsystem 306 in some instances (see supervised steering command 308 indicated by dashed line). In particular, the in-vehicle control computer 150 may transmit the supervised steering command 308 to the steering subsystem 306 based on the vehicle being in an autonomous operation mode/state. In contrast, the in-vehicle control computer 150 may not transmit the supervised steering command 308 to the steering subsystem 306 based on the vehicle being in a manual operation mode/state. In a manual mode, operation of the vehicle is controlled by inputs provided by a human operator or drive located in the vehicle, and the remote server 302 transmits steering commands 304 and other commands to the vehicle in order to facilitate an engagement of an autonomous mode at any time.

Accordingly, even if the vehicle is manual mode and the in-vehicle control computer 150 is not configured to pass a supervised steering command to the steering subsystem 306, the in-vehicle control computer 150 may continue implementing the steering safety module 220 for monitoring the steering commands 304. In doing so, the in-vehicle control computer 150 is able to diagnose a health of the remote server 302 and/or a health of communications between the remote server 302 and the in-vehicle control computer 150.

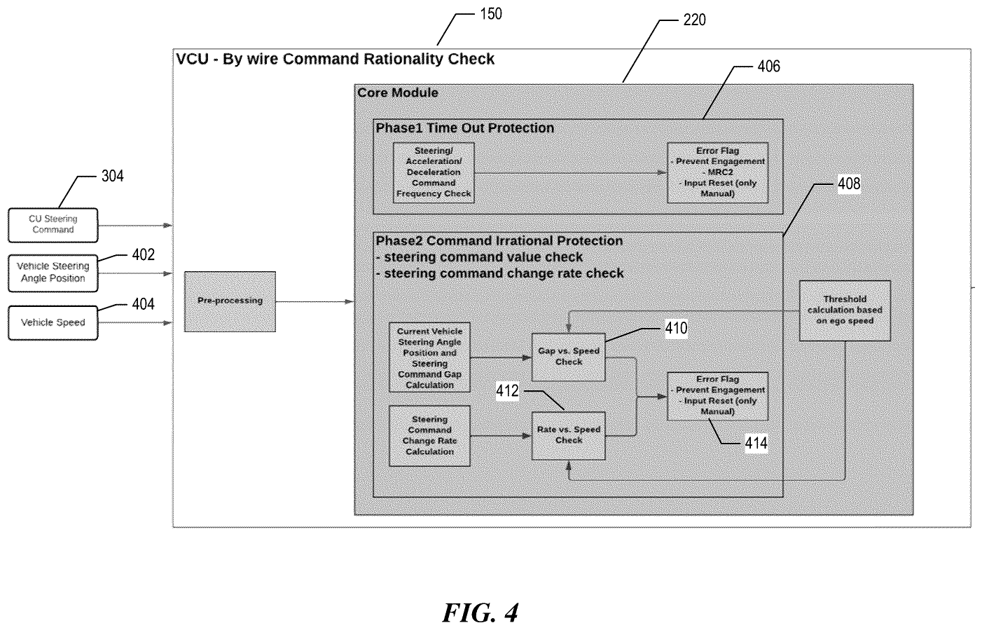

FIG. 4 illustrates a diagram that describes example operations implemented by the steering safety module 220 for monitoring steering commands and diagnosing remote steering functionality for a vehicle. As illustrated in FIG. 4, an in-vehicle control computer 150 (e.g., a vehicle control unit, or VCU) may receive a steering command 304 from a remote server (e.g., a control unit, or CU). To support steering command monitoring, the in-vehicle control computer 150 may also obtain a current vehicle steering angle 402 and a current vehicle speed 404. In some embodiments, the current vehicle steering angle 402 is used to evaluate gap-based rationality of the steering command 304, and the current vehicle speed 404 is used to determine speed-dependent thresholds for various evaluations performed on the steering command 304.

In some embodiments, the in-vehicle control computer 150 may perform various pre-processing operations prior to the steering command monitoring implemented by the steering safety module 220. For example, the in-vehicle control computer 150 may parse the steering command 304, which may include a plurality of fields including steering angle, timestamps, a time delay for the steering, a duration of the steering, and/or the like. In some embodiments, the in-vehicle control computer 150 may convert a heading (e.g., with respect to 360 degrees of headings) indicated by the steering command 304 to a steering angle (e.g., a signed value that may exceed one 360° revolution of a steering wheel). In some embodiments, the in-vehicle control computer 150 performs filtering operations on sensor signals to determine the current vehicle steering angle 402 and the current vehicle speed 404. In some embodiments, the pre-processing operations include transmission error evaluations, such as checksum verifications, hash verifications, and/or the like.

As illustrated in FIG. 4, the steering safety module 220 may implement one or more phases of protection or steering safety, in some embodiments. In an example embodiments, the steering safety module 220 implements a time out protection 406, in which a frequency at which the in-vehicle control computer 150 receives steering commands is determined and evaluated. For example, the time out protection 406 may be used to determine whether the remote server 302 has failed to provide steering commands at a required frequency or at a frequency expected by the in-vehicle control computer 150.

In some embodiments, the steering safety module 220 implements a rationality protection 408 or evaluation. In some embodiments, the rationality protection 408 or evaluation is performed based on the steering command 304 passing the time out protection 406. That is, the rationality protection 408 may be performed subsequent to a successful completion of the time out protection 406.

In some embodiments, the rationality protection 408 includes a gap-based evaluation 410 and a rate-based evaluation 412. The gap-based evaluation 410 includes determining a gap or difference between the steering angle of the steering command 304 and the current vehicle steering angle 402 and comparing the determined gap or difference with a speed-dependent gap threshold. Therefore, as an illustrative example, the gap-based evaluation 410 is configured to evaluate a steering command of 400° as faulty if the vehicle is current being steered at only 30° and if a 370° gap exceeds a speed-dependent gap threshold. Indeed, the gap-based evaluation 410 and the speed-dependent gap thresholds are configured based on an expectation that significantly large gaps between steering commands 304 and current vehicle steering angles 402 are indicative of some error (e.g., in original determination of a steering command 304, in communication and receipt of the steering command 304).

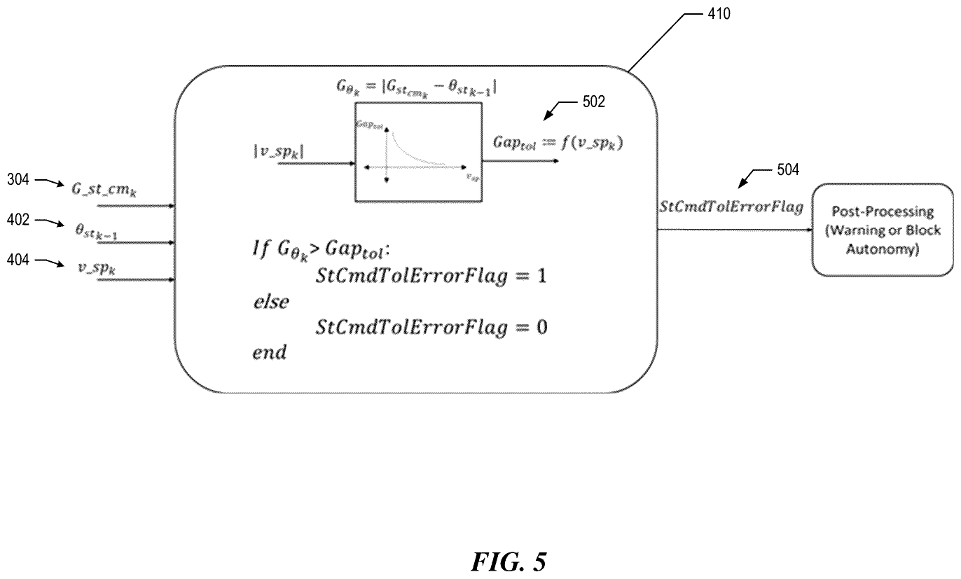

Turning to FIG. 5, an example logic diagram of the gap-based evaluation 410 is shown. As shown, the gap-based evaluation 410 is configured to receive as inputs the steering command 304 (in particular, the steering angle indicated by the steering command 304), the current vehicle steering angle 402, and a current vehicle speed 404. With the current vehicle speed 404, the gap-based evaluation 410 includes a determination of a speed-dependent gap threshold 502 (“Gapₜₒₗ”) that defines whether a given gap is large enough to indicate a steering fault or if the given gap is acceptable at the current vehicle speed 404. The gap-based evaluation 410 may also include a determination of the gap, or the difference between the steering angle indicated by the steering command 304 and the current vehicle steering angle 402.

According to a comparison of the gap and the speed-dependent gap threshold 502, the gap-based evaluation 410 is configured to set a gap flag 504. The gap flag 504 may be set to a particular value in response to the gap being acceptable (e.g., below the speed-dependent gap threshold 502), and the gap flag 504 may be set to another value in response to the gap being unacceptable (e.g., above the speed-dependent gap threshold 502).

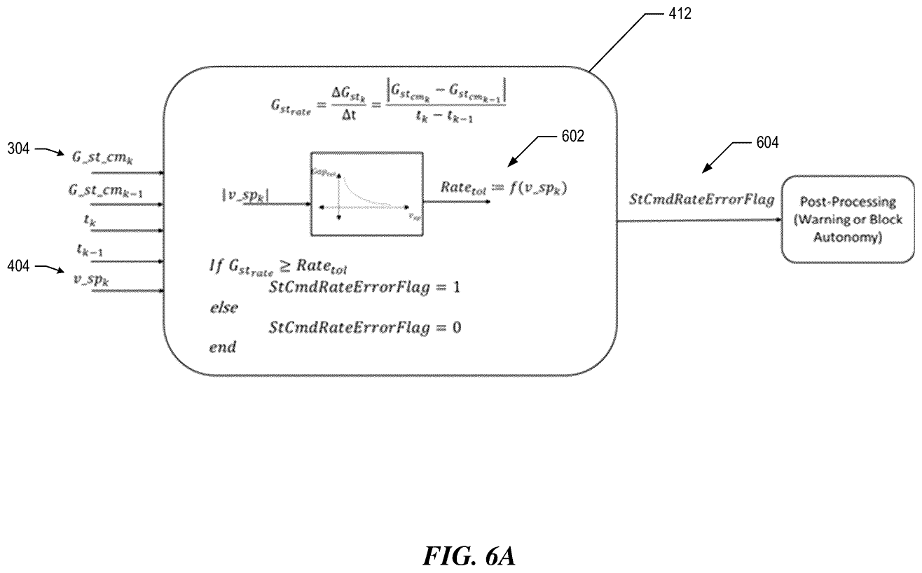

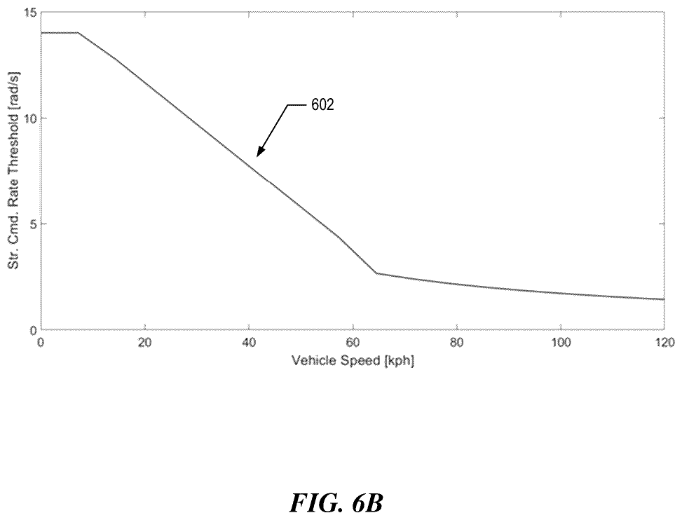

As discussed above, the rationality protection 408 implemented by the steering safety module 220 may include a rate-based evaluation 412, and in some embodiments, the rate-based evaluation 412 may be performed in addition to or in alternative to the gap-based evaluation 410. FIG. 6A shows an example logic diagram of the rate-based evaluation 412. In some embodiments, the rate-based evaluation 412 is configured to receive as inputs the steering command 304 (“G_st_cmₖ”) and one or more preceding steering commands (“G_st_cmₖ₋₁”), time stamps or time steps at which the steering command 304 and the one or more preceding steering commands were received by the in-vehicle control computer 150, and a current vehicle speed 404. As discussed, the rate-based evaluation 412 is configured to detect inconsistent steering commands in the context of other steering commands. For example, if the fifth steering command in a sequence of steering commands spikes to an extreme value of 315° while the remaining nine steering commands have values between 30° and 40°, it is likely that the rate-based evaluation 412 would evaluate the fifth steering command as irregular and invalid, according to a speed-dependent rate threshold.

In some embodiments, the rate-based evaluation 412 calculates a rate (“G_{st_rate}”) for the steering command 304, or a rate of change over time between the steering command and one or more preceding commands. In some embodiments, the rate-based evaluation 412 calculates a slope between the two angle values of the steering command 304 and a preceding command. In some embodiments, the rate-based evaluation 412 calculates a regression fit of the angle values of the steering command and multiple preceding commands and calculates a derivative of the regression fit as the rate. In some embodiments, the rate-based evaluation 412 calculates a regression fit of the angle values of multiple preceding commands and determines an offset or deviation of the angle value of the steering command 304 with respect to the regression fit. The offset or deviation may then be used for an evaluation similar to the gap-based evaluation 410.

Further to determining a rate for the steering command 304, the rate-based evaluation 412 determines a speed-dependent rate threshold 602. The speed-dependent rate threshold 602 defines a plurality of threshold values that vary according to different vehicle speeds, with the threshold values defining whether a given rate is acceptable or unacceptable. An example speed-dependent rate threshold 602 is shown in FIG. 6B. In the illustrated example, steering commands 304 that result in a change of 10 radians per second (with respect to preceding steering commands) may be acceptable at lower vehicle speeds but may be unacceptable at higher vehicle speeds. The rate-based evaluation 412 is then configured to compare the calculated rate with the speed-dependent rate threshold 602 to set a value for a rate flag 604.

Returning to FIG. 4, the respective flags set by the gap-based evaluation 410 and the rate-based evaluation 412 may be used to determine a rationality flag 414. In some embodiments, the rationality flag 414 is used as a final and comprehensive indication (based on weighing both the gap-based evaluation 410 and the rate-based evaluation 412) of whether steering functionality is healthy and whether the steering command can be passed to the vehicle's steering subsystem. In some embodiments, the gap flag 504 set by the gap-based evaluation 410 may be weighed more than the rate flag 604 set by the rate-based evaluation 412. Accordingly, in an example in which the gap flag 504 indicates an error and the rate flag 604 indicates no error, the rationality flag 414 is set to an error value. In some other embodiments, the rate flag 604 may be weighed more than the gap flag 504. In some embodiments, if at least one of the gap flag 504 or the rate flag 604 indicates an error, the rationality flag 414 is automatically set to the error value. In some embodiments, the rationality flag 414 is only set to the error value if both of the gap flag 504 and the rate flag 604 each indicate an error. In some embodiments, the weighing of the gap flag 504 and the rate flag 604 to determine the rationality flag 414 is based on a current operation mode of the vehicle. For example, the gap flag 504 may be weighed more than the rate flag 604 when the vehicle is in a manual operation mode, as steering command consistency is less important when the steering commands are not being applied for vehicle operation. In some embodiments, the gap flag 504 is weighed more than the rate flag 604 when the vehicle is in the manual operation mode, and when the vehicle is in the autonomous operation mode, the gap flag 504 and the rate flag 604 are weighed equally (e.g., either flag indicating an error results in the rationality flag 414 being set to the error value).

The disclosed technology further includes maximum angle evaluations for steering commands 304. A maximum angle evaluation can check whether a steering command 304 indicates an angle that exceeds a maximum angle permitted by a vehicle steering subsystem and/or a maximum angle permitted according to a current vehicle speed. In some embodiments, maximum angle evaluations are preliminary performed by a remote server 302 prior to transmitting a steering command 304 to the in-vehicle control computer 150 and/or performed by the in-vehicle control computer 150 prior to performing gap-based evaluations 410 and rate-based evaluations 412. In some embodiments, the remote server 302 receives speed measurements of the vehicle so that the remote server 302 is able to use speed-dependent thresholds for maximum angle evaluations.

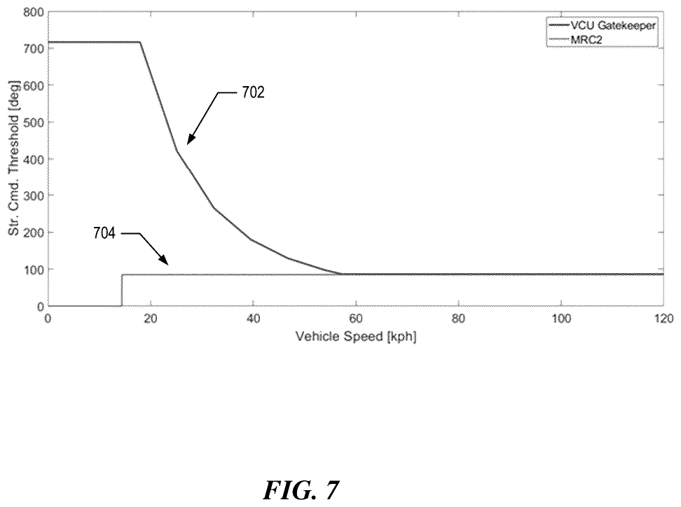

FIG. 7 illustrates two example speed-dependent thresholds configured to be used for maximum angle evaluations. A first threshold 702 is shown and is associated with steering commands 304 received by the in-vehicle control computer 150 from the remote server 302. A second threshold 704 is shown and is associated with steering commands locally determined by the in-vehicle control computer 150 to maneuver the vehicle after a minimal risk condition (MRC) has been triggered. For example, in the MRC, the in-vehicle control computer 150 has determined that commands from the remote server 302 are unreliable and locally determines vehicle maneuvers to bring the vehicle to a state of minimal risk, such as a complete stop. Due to the increased risk in the MRC, the second threshold 704 is lower than the first threshold 702 at lower speeds to constrain maneuvering of the vehicle.

In the illustrated example, the first threshold 702 is set at the maximum steering angle limit of 720 degrees for lower speeds, and in particular, for speeds lower than approximately 15 m/s (e.g., lower than 14.5 m/s, lower than 15.5 m/s, lower than 15.9 m/s, lower than 16.4 m/s, lower than 18.0 m/s, lower than 18.5 m/s). In some embodiments, speed-dependent thresholds disclosed herein, including the first threshold 702 and the second threshold 704, are piecewise functions at approximately 15 m/s, or behave differently on either side of a particular speed that is approximately 15 m/s. In some embodiments, the particular speed that is approximately 15 m/s separates speeds associated with vehicle operation on local roadways and speeds associated with vehicle operation on high-speed roadways (e.g., highways). Thus, in some embodiments, speed-dependent thresholds are defined with different characteristics on either side of approximately 15 m/s. For example, the first threshold 702 of FIG. 7 may be defined according Equation 1 shown below. In some embodiments, the particular speed at which a speed-dependent threshold may deviate from approximately 15 m/s based on various factors, including vehicle weight, vehicle length, roadway surface type, and/or the like. In some embodiments, an in-vehicle control computer 150 determines a speed-dependent threshold based on determining whether the current vehicle speed is greater than approximately 15 m/s or less than approximately 15 m/s. In some embodiments, the in-vehicle control computer 150 determines a speed-dependent threshold based on determining whether the vehicle is operating on a local roadway or on a high-speed roadway.

$$if v \text{?} < 15.919 m / s \text{?} \qquad Equation 1$$

$$\text{?} \text{?} \text{?} = \text{?} ( \frac{k \text{?} \text{?} \text{?}}{\text{?} \text{?} \text{?}} ) \text{?} \text{?}$$

$$else :$$

$$\text{?} \text{?} \text{?} = \frac{k \text{?}}{44.86} \text{?} \text{?}$$

$$end$$

$$\text{?} \text{?} \text{?} = min ( θ \text{?} \text{?} , \text{?} \text{?} )$$

$$where$$

$$v \text{?} = max ( v \text{?} 0.00001 ) \text{?}$$

$$k \text{?} = 4 m / s \text{?} \text{?}$$

$$L \text{?} = 5.65 \text{?} \text{?}$$

$$\text{?} = 16.9 ,$$

$$k \text{?} = 12.5 rad$$

$$\text{?} \text{indicates text missing or illegible when filed}$$

Embodiments are described and illustrated herein with reference to speed-dependent thresholds. In some embodiments, the thresholds (e.g., gap thresholds, rate thresholds) are dependent upon other factors as well. In some examples, speed-dependent thresholds are further based on tractor-trailer angle. For example, steering of a tractor is limited in a particular direction (via a lower threshold) when a trailer attached to the tractor is also angled (with respect to the tractor) in the particular direction. As another example, steering of a tractor in either direction is limited (via lower thresholds) when higher magnitudes of tractor-trailer angles are detected. In some examples, speed-dependent thresholds are further based on environmental conditions. For example, steering of a vehicle is limited (via lower thresholds) due to wet roadway conditions being detected or indicated. In some examples, speed-dependent thresholds are modified based on a density measure of a roadway on which the vehicle is located (e.g., thresholds are lowered on dense roadways for tighter steering).

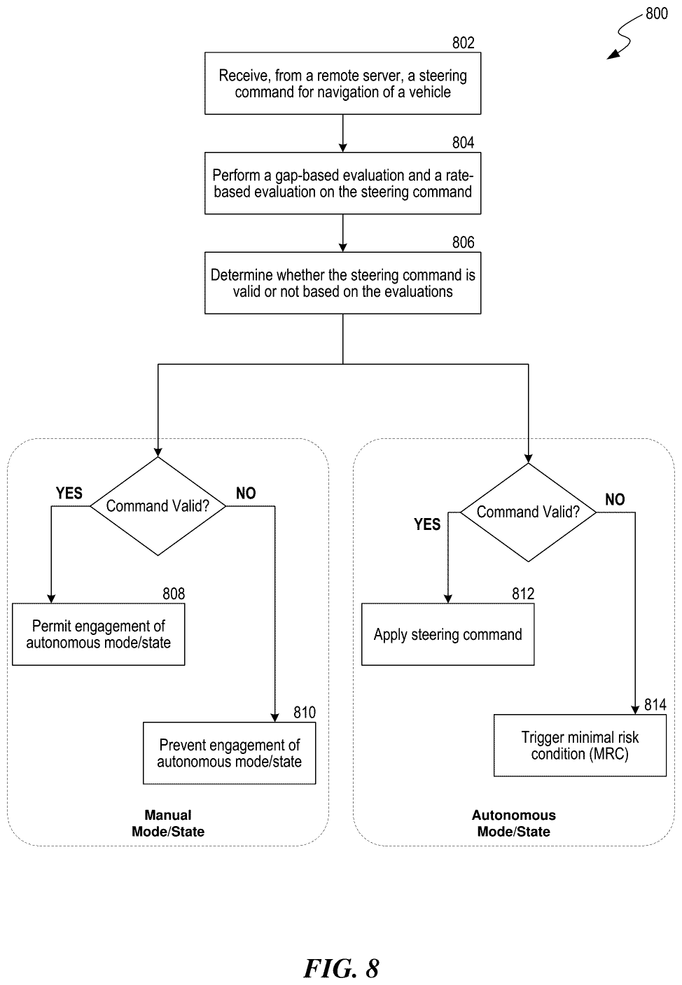

FIG. 8 illustrates a flow diagram of a method 800 implemented to improve safety of parking brake actuation and engagement in a vehicle is illustrated. Example operations of the method may be performed by the computing device 200, which may be embodied by the in-vehicle control computer 150 or components or modules thereof. As shown, some of the example operations may be implemented by the steering safety module 220 of the computing device 200. In some embodiments, the example operations of method 800 are performed by a device located in a vehicle.

At 802, the device receives a steering command for navigation of a vehicle from a remote server. The steering command includes a steering angle to apply to a steering subsystem of the vehicle to cause the vehicle to travel in a particular direction.

At 804, the device performs a gap-based evaluation and a rate-based evaluation on the steering command. Each of the gap-based evaluation and the rate-based evaluation include a speed-dependent threshold and respectively compare the steering angle to a current vehicle steering angle and one or more steering angles of preceding steering commands.

At 806, the devices determines whether the steering command is valid or not according to respective flags set by the gap-based evaluation and the rate-based evaluation. In some embodiments, the determination of whether the steering command is valid or not may be based on one or both of the gap-based evaluation and the rate-based evaluation. In some embodiments, the determination of whether the steering command is valid or not is based on whether the vehicle is currently in a manual operation mode or an autonomous operation mode.

As illustrated in FIG. 8, the device may arbitrate the determined validity (or invalidity) of the steering command differently according to the operation mode or state of the vehicle. In the manual operation mode, steering commands from the remote server are not necessarily applied in vehicle operation, but the determined validity of the steering commands is indication of a health of autonomous steering functionality of the vehicle.

Accordingly, at 808, the device permits engagement of the autonomous mode in response to the steering command being valid. For example, based on the steering command being valid, the device determines that autonomous steering functionality is healthy, and may permit engagement of the autonomous mode. To permit the engagement of the autonomous mode, the device may transmit instructions to or operate an in-vehicle user interface (e.g., a touch screen, a button, a lever) to allow engagement of the autonomous mode via the in-vehicle user interface. For example, a touch screen interface feature for engaging the autonomous mode is enabled by the device at 808. Alternatively, at 810, the device prevents engagement of the autonomous mode in response to the steering command being invalid. Similarly, the device may transmit instructions or operate the in-vehicle user interface to prevent an operator from engaging the autonomous mode of the vehicle. For example, the device may transmit instructions to cause a touch screen interface feature for engaging the autonomous mode to be greyed out.

In the autonomous mode, the determined validity (or invalidity) of the steering command results in the steering command being applied or not. In particular, at 812, the device applies the steering command in response to the steering command being valid. To apply the steering command, the device transmits instructions to a steering subsystem to cause the steering subsystem to point one or more wheels/tires of the vehicle in a particular direction according to the steering angle. For example, the instructions include the steering angle. Alternatively, at 814, the device triggers a minimal risk condition (MRC) maneuver and does not apply the steering command in response to the steering command being invalid. Instead, the MRC maneuver that is trigger relies upon locally-determined navigation (e.g., including locally-determined steering angles) based on an assumption that the remote server and/or communication therewith is compromised. Via the MRC maneuver, the vehicle is maneuvered to a complete stop at a safe location.

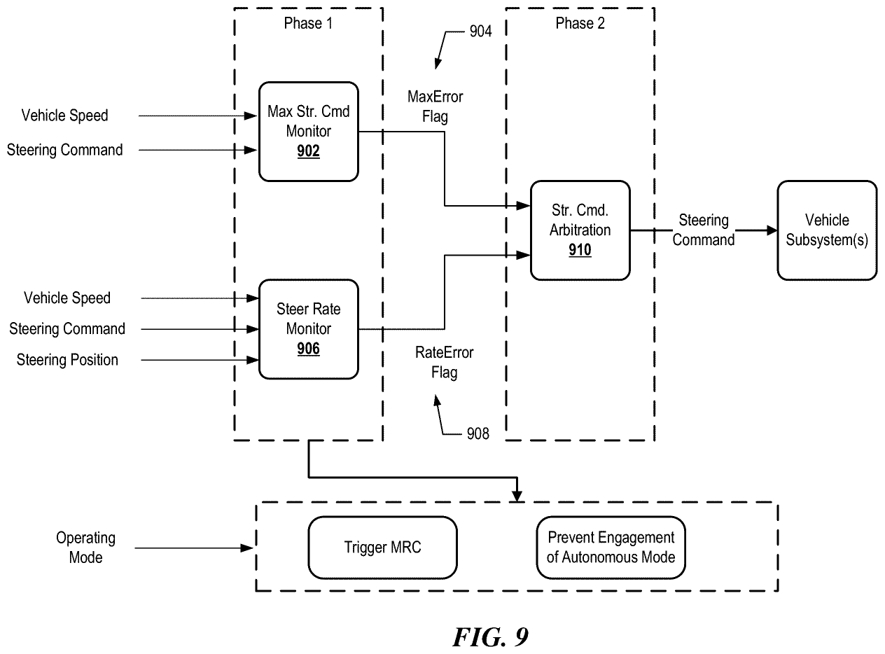

FIG. 9 illustrates another example embodiment that includes a multi-phase evaluation of a remote steering command received at a vehicle. FIG. 9 includes a block diagram including example operations implemented by an in-vehicle control computer to safely operate a vehicle in response to a steering command received from a remote server.

In first phase or stage (“Phase 1”), the in-vehicle control computer can perform a maximum angle evaluation and a steering rate evaluation in response to receiving a steering command from a remote server. The maximum angle evaluation 902 performed by the in-vehicle control computer involves determining whether a steering angle (e.g., a direction-agnostic angle magnitude) indicated by the steering command exceeds a speed-dependent threshold corresponding to a current speed of the vehicle. In some embodiments, the in-vehicle control computer performs the maximum angle evaluation 902 similar to the example operations described with FIG. 7 and Equation 1 above. As shown in FIG. 9, the in-vehicle control computer can use a vehicle speed for the maximum angle evaluation 902, and in some embodiments, the in-vehicle control computer samples the vehicle speed at a predetermined frequency (e.g., every 100 milliseconds) to perform the maximum angle evaluation 902. Based on whether the steering command exceeds the speed-dependent threshold in the maximum angle evaluation 902, the in-vehicle control command can determine or set a maximum error flag 904.

The in-vehicle control computer also performs the steering rate evaluation 906 in the first phase or stage, such that both a magnitude of the steering command and a relative difference between the steering command and previous commands are evaluated. In some embodiments, the in-vehicle control computer performs the steering rate evaluation 906 according to the example operations described with FIGS. 6A-6B above. In some embodiments, the in-vehicle control computer performs the steering rate evaluation 906 based on obtaining a plurality of steering angles indicating by a sequence of steering commands (e.g., commands preceding and including the presently-receiving steering command), determining a curve fit for the plurality of steering angles (e.g., a third-degree polynomial fit), determining a derivative of the curve fit, and comparing the derivative with a speed-dependent threshold with respect to angle rate of change. In some examples, the steering rate evaluation 906 is performed using a sequence of five steering commands. Algorithm 1 shown below is an illustrative example of how the in-vehicle control computer determines the steering rate for the steering rate evaluation 906.

$$function steer\_rate = fcn ( steer\_cmd \_vec ) \qquad Algorithm 1$$

$$x = linspace ( - \text{.16} , 0 , 5 ) ;$$

$$poly = polyfit ( x , steer\_cmd {\_vec}^{′} , 3 ) ;$$

$$poly\_der = polyder ( poly ) ;$$

$$steer\_rate = polyval ( poly\_der , 0 ) / 25 ;$$

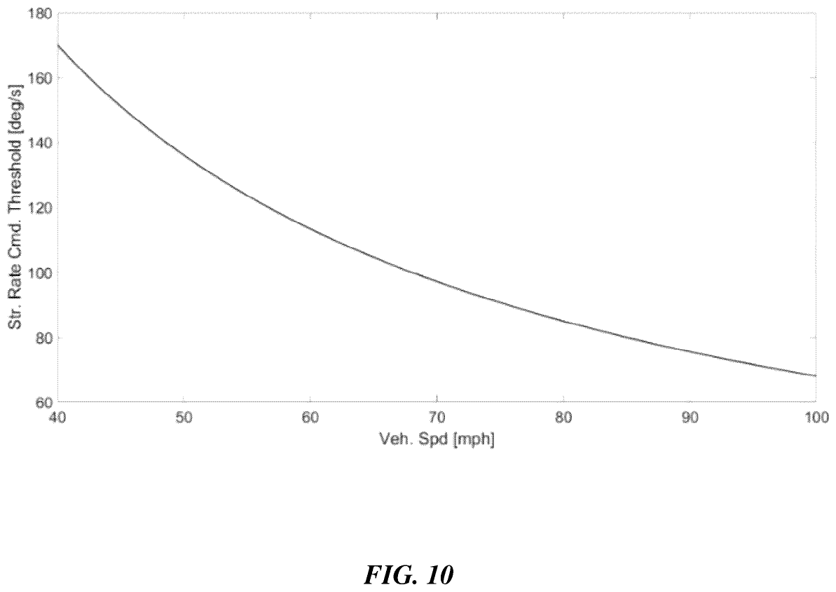

FIG. 10 illustrates an example speed-dependent rate threshold used in the steering rate evaluation 906 by the in-vehicle control computer. In the illustrated example, the permitted rate of change of successive steering commands is lower at higher vehicle speeds. According to some embodiments, the in-vehicle control computer performs the steering rate evaluation 906 in the first phase/stage when the vehicle speed is higher than a particular speed. In the illustrated example, the in-vehicle control computer performs the steering rate evaluation 906 if the vehicle is traveling at least above 40 miles per hour. In other examples, the particular speed above which the in-vehicle control computer performs the steering rate evaluation 906 is a pre-determined speed that separates local driving conditions and high-speed roadway driving conditions. For example, the particular speed is 15.919 m/s (as indicated in Equation 1) or another suitable speed.

Equation 2 below defines an example speed-dependent rate threshold. In Equation 2, the speed-dependent rate threshold is different when the vehicle speed is: (i) below 2.235 m/s (5 mph), (ii) between 2.235 m/s and 17.8816 m/s (40 mph), and (iii) above 17.8816 m/s. These three portions of the speed-dependent rate threshold can represent three different driving conditions or settings, in which steering rate is monitored differently.

$$if \text{:} v \text{?} \leq 2.235 m / ε \qquad Equation 2$$

$${Rate}_{threshold} = 14 \text{?} / \text{?}$$

$$else if \text{:} 2.235 m / s < v \text{?} < 17.8816 m / s$$

$${Rate}_{threshold} = - 0.7056 \text{?} + 15.577 \% Linear interpolation$$

$$\% between \{ 2.235 \text{?} 14$$

$$and$$

$$[ 18.8816 \text{?} 2 \text{?} 96 ]$$

$$else :$$

$${Rate}_{threshold} = ( kSteeringRateMaxSoft / non\_zero \_v * nominal\_speed ) * {Sample}_{rate}$$

$$end$$

$$where$$

$${Sample}_{rate} = 25 Hz$$

$$non\_zero \_v = max ( v \text{?} \text{?} 1 e - 5 )$$

$$Nominal\_speed = 29.06 m / s$$

$$kSteeringRateMaxSoft = 0.073$$

$$\text{?} \text{indicates text missing or illegible when filed}$$

Returning to FIG. 9, the in-vehicle control computer determines or sets a rate error flag 908 if the determined steering angle rate exceeds the speed-dependent rate threshold. Accordingly, the in-vehicle control computer can determine two flags corresponding to the two evaluations in the first phase or stage of steering command monitoring.

Depending on the current operating mode of the vehicle, the in-vehicle control computer can use the two flags determined at the first phase/stage to trigger an MRC condition and/or maneuver or to prevent the engagement of an autonomous driving mode or state of the vehicle. In particular, according to some embodiments, the in-vehicle control computer triggers the MRC condition/maneuver and prevents autonomous engagement based on a duration or a number of frames in which either of the flags are set.

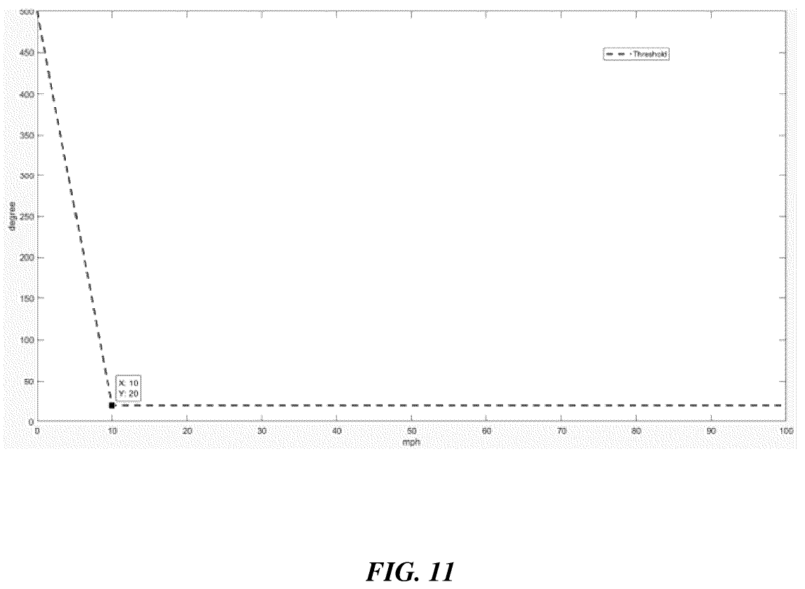

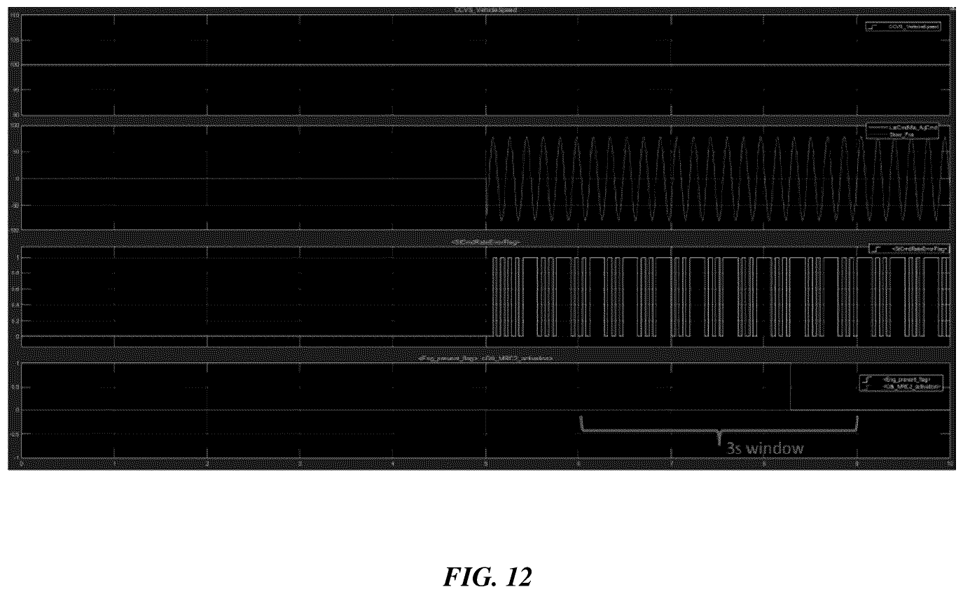

The in-vehicle control computer is configured to trigger an MRC condition in response to any one or more of the following conditions if the vehicle is presently in an autonomous driving mode/state. By triggering the MRC condition, the in-vehicle control computer causes the vehicle to exit the autonomous driving mode/state in order to resolve and diagnose inaccuracies or violations of the received steering command. The following conditions can trigger MRC activation:
1. Maximum value threshold is violated (e.g., according to the maximum angle evaluation 902) for one frame, or for a predetermined number of evaluations. As referred to herein, a frame refers to a unit or period of time in which the in-vehicle control computer evaluates a steering command and can correspond to an operating frequency of the in-vehicle control computer.
2. The steering command violates a gap-based evaluation (e.g., a gap-based evaluation similar to those described with FIGS. 4-5 above) for more than one second, or a predetermined length of time. The predetermined length of time (e.g., one second) can be a data-driven refinement. The gap-based evaluation relates to a difference between the steering command and a current steering position of the vehicle, and includes a speed-dependent gap threshold. FIG. 11 illustrates an example speed-dependent gap threshold. In the illustrated example, the permitted gap or difference between a steering command and a current steering position or angle is 20 degrees when the vehicle speed is greater than 10 mph. In contrast with other example embodiments, the gap-based evaluation is implemented here as a condition for MRC activation in order to avoid false positive when setting evaluation flags for the steering command. Furthermore, rather than a one-time independent or isolated gap-based evaluation, this condition requires multiple gap-based evaluations over time to similarly reduce accidental and unintended triggering of MRC.
3. The rate threshold is consistently violated (e.g., according to the steering rate evaluation 906) for 0.5 seconds, or a predetermined length of time.
4. The rate threshold is violated for more than 50% of the frames in a three-second moving window (or a predetermined portion of frames in a predetermined length of time). This condition provides an oscillation escape, in order to detect oscillating steering commands. FIG. 12 demonstrates an example of this condition being used to trigger MRC activation. In FIG. 12, steering commands received by the in-vehicle control computer are rapidly oscillating, and the rate error flag 908 is being occasionally set in response to the oscillations and the changes over the steering commands. Once the rate error flag 908 has been cumulatively set for at least 50% of the frames in the three-second window, MRC activation is automatically triggered.

If the vehicle is instead presently in a manual driving mode/state, the in-vehicle control computer is configured to prevent engagement of the autonomous driving mode/state in response to any one or more of the following conditions:
1. Maximum value threshold is violated (e.g., according to the maximum angle evaluation 902) for one frame, or for a predetermined number of evaluations.
2. A speed-dependent gap threshold is violated (e.g., according to a gap-based evaluation) for one frame, or for a predetermined number of evaluations. The example speed-dependent gap threshold illustrated in FIG. 11 for MRC triggering can be similarly applied here for autonomy engagement prevention.

Returning to FIG. 9, the in-vehicle control computer further arbitrates or corrects steering commands in a second phase or stage (“Phase 2”). In some embodiments, the in-vehicle control computer performs a steering command arbitration 910 concurrently with the MRC triggering or autonomy engagement prevention. In some embodiments, the in-vehicle control computer performs this arbitration subsequent to the MRC triggering or autonomy engagement prevention. In this second phase/stage, the in-vehicle control computer modifies steering commands that have been flagged according to the evaluations in the first phase/stage and can transmit the corrected/modified steering commands to vehicle subsystems (e.g., if the vehicle is in an autonomous driving mode/state). The in-vehicle control computer performs the steering command arbitration 910 in order to modify a flagged steering command such that the steering command complies and does not violate the evaluations.

In some embodiments, the in-vehicle control computer performs the steering command arbitration 910 when the vehicle is in the autonomous driving mode/state. In some embodiments, if the vehicle is in the manual driving mode/state, the in-vehicle control computer does not need to perform the steering command arbitration 910.

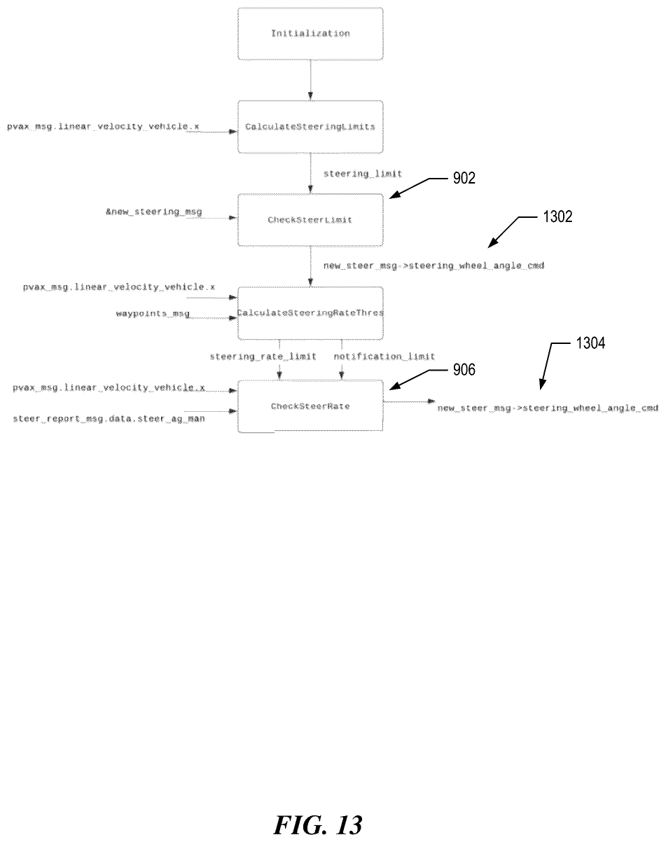

FIG. 13 includes a flow diagram that illustrates example operations implemented by the in-vehicle control computer to perform steering command arbitration. At 1302, the in-vehicle control computer clips the steering command (or the steering angle indicated therein) to the maximum angle threshold, in response to the steering command violating the maximum angle evaluation 902. In some embodiments, the in-vehicle control computer clips the steering command according to Algorithm 2 shown below.

$$if \text{?} \vert Str . cmd \vert \geq Str . limit \qquad Algorithm 2$$

$$Str . cmd = sign ( Str . cmd ) * Str . limit$$

$$end$$

$$\text{?} \text{indicates text missing or illegible when filed}$$

According to the example flow of FIG. 13, the clipped steering command determined at 1302 is then provided to the steering rate evaluation 906, and if the steering command violates the steering rate evaluation 906, the steering command is (further) modified at 1304. Thus, in the illustrated embodiment of FIG. 13, the in-vehicle control computer performs the maximum angle evaluation 902 first and arbitrates the steering command accordingly (if necessary) prior to performing the steering rate evaluation 906. In other embodiments, the in-vehicle control computer can conversely perform the steering rate evaluation 906 first prior to the maximum angle evaluation 902.

In some embodiments, the in-vehicle control computer modifies, at 1304, the steering command (e.g., an original command that passed the maximum angle evaluation 902, a modified command that initially violated the maximum angle evaluation 902) according to Algorithm 3 shown below. As indicated in Algorithm 3, the steering command can be modified according to a current steering position. In particular, Str.window in Algorithm 3 refers to a vector formed by the steering command and the current steering position (e.g., as indicated by a previous steering command, an actual steering position of the vehicle).

$$if v \text{?} > 17.88 m / s \qquad Algorithm 3$$

$$Str . rate = CalculateSteeringRate ( Str . window . Str . cmd )$$

$$if \text{?} \vert Str . rate \vert > Str . rate limit$$

$$Str . cmd = Str . window ( end ) + ( str . rate \text{?} \text{?} 0.04 \text{?} ) \text{?} sign ( ( Str . cmd - Str . window ( end ) ) )$$

$$end$$

$$end$$

$$\text{?} \text{indicates text missing or illegible when filed}$$

Thus, according to FIG. 13, the in-vehicle control computer can perform at least two layers of steering command arbitration, corresponding to the at least two types of evaluations performed on a steering command.

The following technical solutions may be implemented by some preferred embodiments.

1. A method for monitoring steering operation of a vehicle, comprising: receiving, by an in-vehicle controller from a remote server, a steering command that indicates a steering angle for navigation of the vehicle; performing, by the in-vehicle controller, a gap-based rationality evaluation and a rate-based rationality evaluation on the steering angle indicated by the steering command, wherein the gap-based rationality evaluation compares a difference between the steering angle and a current vehicle steering angle against a first speed-dependent threshold, and wherein the rate-based rationality evaluation compares a rate of change of the steering angle with one or more preceding steering commands against a second speed-dependent threshold; determining, by the in-vehicle controller, whether the steering command is valid or not based on weighing respective flags set by the gap-based rationality evaluation and the rate-based rationality evaluation according to a current operation mode of the vehicle; and in accordance with the current operation mode being a manual operation mode and a determination that the steering command is not valid, transmitting, by the in-vehicle controller, instructions to an in-vehicle user interface to cause the in-vehicle user interface to disable engagement of an autonomous operation mode for the vehicle via the in-vehicle user interface.

2. The method of solution 1, further comprising: performing, by the in-vehicle controller, the gap-based rationality evaluation and the rate-based rationality evaluation on a second steering angle indicated by a second steering command; and in accordance with (i) the current operation mode being an autonomous operation mode and (ii) a determination that the second steering command is not valid based on the gap-based rationality evaluation and the rate-based rationality evaluation, triggering, by the in-vehicle controller, a maneuver for the vehicle to reach a complete stop.

3. The method of example 2, wherein the maneuver includes locally-determined steering angles determined by the in-vehicle controller in accordance with a third speed-dependent threshold associated with the maneuver.

4. The method of solution 1, further comprising: performing, by the in-vehicle controller, the gap-based rationality evaluation and the rate-based rationality evaluation on a second steering angle indicated by a second steering command; and in accordance with (i) the current operation mode being an autonomous operation mode and (ii) a determination that the steering command is valid based on the gap-based rationality evaluation and the rate-based rationality evaluation, applying, by the in-vehicle controller, the second steering command by controlling a steering subsystem of the vehicle.

5. The method of any one of solutions 1-4, further comprising: receiving, by the in-vehicle controller from a sensor subsystem located in the vehicle, a vehicle speed measurement; and determining, by the in-vehicle controller, the first speed-dependent threshold for the gap-based rationality evaluation and the second speed-dependent threshold for the rate-based rationality evaluation based on the vehicle speed measurement.

6. The method of any one of solutions 1-4, further comprising: receiving, by the in-vehicle controller from a sensor subsystem located in the vehicle, the current vehicle steering angle.

7. The method of any one of solutions 1-4, further comprising: determining, by the in-vehicle controller, a regression fit for a plurality of steering angles indicating by the steering command and the one or more preceding steering commands; and performing, by the in-vehicle controller, the rate-based rationality evaluation with a derivative of the regression fit as the rate of change.

8. An in-vehicle controller for an autonomous vehicle, the in-vehicle controller comprising a processor and a memory storing executable code configured to cause the in-vehicle controller to: receive, from a remote server, a steering command that indicates a steering angle for navigation of the autonomous vehicle; perform a gap-based rationality evaluation and a rate-based rationality evaluation on the steering angle indicated by the steering command, wherein the gap-based rationality evaluation compares a difference between the steering angle and a current vehicle steering angle against a first speed-dependent threshold, and wherein the rate-based rationality evaluation compares a rate of change of the steering angle with one or more preceding steering commands against a second speed-dependent threshold; determine whether the steering command is valid or not based on weighing respective flags set by the gap-based rationality evaluation and the rate-based rationality evaluation according to a current operation mode of the autonomous vehicle; and in accordance with the current operation mode being a manual operation mode and a determination that the steering command is not valid, transmit instructions to an in-vehicle user interface to cause the in-vehicle user interface to disable engagement of an autonomous operation mode for the autonomous vehicle via the in-vehicle user interface.

9. The in-vehicle controller of solution 8, wherein the executable code is further configured to cause the in-vehicle controller to: in accordance with the current operation mode being the manual operation mode and a determination that the steering command is valid, classify a steering functionality of the autonomous vehicle as healthy; and permit engagement of the autonomous operation mode for the autonomous vehicle.

10. The in-vehicle controller of solution 8, wherein the executable code is further configured to cause the in-vehicle controller to: in accordance with the current operation mode being the autonomous operation mode and the determination that the steering command is not valid, trigger a maneuver for the autonomous vehicle to reach a complete stop.

11. The in-vehicle controller of solution 10, wherein the maneuver includes one or more locally-determined steering angles determined by the in-vehicle controller in accordance with a third speed-dependent threshold associated with the maneuver.

12. The in-vehicle controller of solution 8, wherein the executable code is further configured to cause the in-vehicle controller to: in accordance with the current operation mode being the autonomous operation mode and a determination that the steering command is valid, apply the steering command by transmitting instructions to a steering subsystem of the autonomous vehicle.

13. The in-vehicle controller of any one of solutions 8-12, wherein the executable code is further configured to cause the in-vehicle controller to: receive, from a sensor subsystem located in the autonomous vehicle, a vehicle speed measurement; and determine the first speed-dependent threshold for the gap-based rationality evaluation and the second speed-dependent threshold for the rate-based rationality evaluation based on the vehicle speed measurement.

14. The in-vehicle controller of any one of solutions 8-12, wherein the executable code is further configured to cause the in-vehicle controller to: receive, from a sensor subsystem located in the autonomous vehicle, the current vehicle steering angle.

15. The in-vehicle controller of any one of solutions 8-12, wherein the executable code is further configured to cause the in-vehicle controller to: determine a regression fit for a plurality of steering angles indicating by the steering command and the one or more preceding steering commands; and perform the rate-based rationality evaluation with a derivative of the regression fit as the rate of change.

16. An autonomous truck comprising: a steering subsystem configured to orient one or more wheels of the autonomous truck to cause the autonomous truck to travel in a particular direction; and an in-vehicle controller that is configured to: receive, from a remote server, a steering command that indicates a steering angle for the steering subsystem; perform a gap-based rationality evaluation and a rate-based rationality evaluation on the steering angle indicated by the steering command, wherein the gap-based rationality evaluation compares a difference between the steering angle and a current vehicle steering angle against a first speed-dependent threshold, and wherein the rate-based rationality evaluation compares a rate of change of the steering angle with one or more preceding steering commands against a second speed-dependent threshold; determine whether the steering command is valid or not based on weighing respective flags set by the gap-based rationality evaluation and the rate-based rationality evaluation according to a current operation mode of the autonomous truck; and in accordance with the current operation mode being an autonomous operation mode and a determination that the steering command is valid, transmit, to the steering subsystem, instructions that include the steering angle to cause the steering subsystem to orient the one or more wheels according to the steering angle.

17. The autonomous truck of solution 16, wherein the in-vehicle controller is further configured to: in accordance with the current operation mode being an autonomous operation mode and a determination that the steering command is not valid, trigger a maneuver for the autonomous truck to reach a complete stop.

18. The autonomous truck of solution 17, wherein the maneuver includes locally-determined steering angles determined by the in-vehicle controller in accordance with a third speed-dependent threshold associated with the maneuver.

19. The autonomous truck of solution 16, wherein the in-vehicle controller is further configured to: in accordance with the current operation mode being a manual operation mode and a determination that the steering command is not valid, prevent engagement of the autonomous operation mode.

20. The autonomous truck of solution 16, wherein the in-vehicle controller is further configured to: in accordance with the current operation mode being a manual operation mode and a determination that the steering command is valid, permit engagement of the autonomous operation mode.

21. The autonomous truck of any one of solutions 16-20, wherein the in-vehicle controller is further configured to: receive, from a sensor subsystem located in the autonomous truck, a vehicle speed measurement; and determine the first speed-dependent threshold for the gap-based rationality evaluation and the second speed-dependent threshold for the rate-based rationality evaluation based on the vehicle speed measurement.

22. The autonomous truck of any one of solutions 16-20, wherein the in-vehicle controller is further configured to: receive, from a sensor subsystem located in the autonomous truck, the current vehicle steering angle.

23. The autonomous truck of any one of solutions 16-20, wherein the in-vehicle controller is further configured to: determine a regression fit for a plurality of steering angles indicating by the steering command and the one or more preceding steering commands; and perform the rate-based rationality evaluation with a derivative of the regression fit as the rate of change.

24. A remote server for autonomously operating a vehicle, the remote server being configured to: receive, from an in-vehicle controller located in the vehicle, vehicle telemetry data that includes a current vehicle speed; determine a steering command for navigation of the vehicle in accordance with a planned route of the vehicle, wherein the steering command is determined to comply with a steering angle threshold that is based on the current vehicle speed; in response to transmitting the steering command to the in-vehicle controller, receive an error response that indicates that the steering command fails one or more rationality evaluations in which the steering command is compared to a current vehicle steering angle and/or one or more preceding steering commands; and reconfigure the steering command according to the error response.

25. The remote server of solution 24, wherein the error response includes the current vehicle steering angle and a gap threshold, and wherein the steering command is reconfigured based on the current vehicle steering angle and the gap threshold.

26. The remote server of any one of solutions 24-25, wherein the error response indicates that a minimal risk condition maneuver has been triggered in response to the steering command.

27. A non-transitory computer-readable program storage medium having code stored thereon, the code, when executed by a processor, causing the processor to implement a method of any of solutions 1-7.

28. A method for improving safety of a vehicle that receives steering commands from a remote server, the method comprising: receiving, by an in-vehicle controller from a remote server, a steering command that indicates a steering angle for the vehicle; evaluating, by the in-vehicle controller, the steering command against at least two speed-dependent thresholds that are determined based on a current speed of the vehicle, wherein the at least two speed-dependent thresholds includes an angle rate threshold that describes a change in steering angles with respect to preceding steering commands received by the in-vehicle controller; in response to the steering command failing to satisfy a particular speed-dependent threshold, modify the steering angle of the steering command to a particular value that causes the steering command to satisfy the particular speed-dependent threshold; and based on the vehicle being operated in an autonomous driving mode, transmit the steering command with the modified steering angle to one or more vehicle subsystems of the vehicle to cause the vehicle to steer according to the modified steering angle.

29. The method of solution 28, further comprising: determining that a difference between the steering angle and a current steering position fails to satisfy a gap threshold for at least a predetermined length of time; and according to whether the vehicle is in a manual operating mode or an autonomous operating mode, respectively (i) prevent engagement of the autonomous operating mode, or (ii) trigger an emergency maneuver for the vehicle.

30. The method of any of solutions 28-29, further comprising: determining a number of frames in a predetermined time window in which the steering command fails to satisfy the angle rate threshold; and based on the number of frames exceeding a particular percentage of the predetermined time window, trigger an emergency maneuver for the vehicle.

31. The method of any of solutions 28-30, wherein evaluating the steering command against the angle rate threshold includes: determining a curve fit for respective steering angles of the preceding steering commands and the received steering command; calculating a derivative value from the curve fit, wherein the derivative value represents an angle rate indicated by the receiving steering command; and comparing the derivative value to the angle rate threshold; and in response to the derivative value exceeding the angle rate threshold, setting an error flag that corresponding to the angle rate threshold.

In this document the term “exemplary” is used to mean “an example of” and, unless otherwise stated, does not imply an ideal or a preferred embodiment. In this document, the term “microcontroller” can include a processor and its associated memory.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements and variations can be made based on what is described and illustrated in this disclosure.

1. An in-vehicle controller for an autonomous vehicle, the in-vehicle controller comprising a processor and a memory storing executable code configured to cause the in-vehicle controller to:
receive, from a remote server, a steering command that indicates a steering angle for navigation of the autonomous vehicle;
evaluate the steering command against at least two speed-dependent thresholds, the at least two speed-dependent thresholds comprising a first speed-dependent threshold with respect to a difference between the steering angle and a current vehicle steering angle and a second speed-dependent threshold with respect to a rate of change of the steering angle with one or more preceding steering commands;
determine whether the steering command is valid or not based on weighing, according to a current operation mode of the autonomous vehicle, respective flags resulting from the at least two speed-dependent thresholds; and
in accordance with the current operation mode being a manual operation mode and a determination that the steering command is not valid, transmit instructions to an in-vehicle user interface to cause the in-vehicle user interface to disable engagement of an autonomous operation mode for the autonomous vehicle via the in-vehicle user interface.

2. The in-vehicle controller of claim 1, wherein the executable code is further configured to cause the in-vehicle controller to:
in accordance with the current operation mode being the manual operation mode and a determination that the steering command is valid, classify a steering functionality of the autonomous vehicle as healthy; and
permit engagement of the autonomous operation mode for the autonomous vehicle.

3. The in-vehicle controller of claim 1, wherein the executable code is further configured to cause the in-vehicle controller to:
in accordance with the current operation mode being the autonomous operation mode and the determination that the steering command is not valid, trigger a maneuver for the autonomous vehicle to reach a complete stop.

4. The in-vehicle controller of claim 3, wherein the maneuver includes one or more locally-determined steering angles determined by the in-vehicle controller in accordance with a third speed-dependent threshold associated with the maneuver.

5. The in-vehicle controller of claim 1, wherein the executable code is further configured to cause the in-vehicle controller to:
in accordance with the current operation mode being the autonomous operation mode and a determination that the steering command is valid, apply the steering command by transmitting instructions to a steering subsystem of the autonomous vehicle.

6. The in-vehicle controller of claim 1, wherein the executable code is further configured to cause the in-vehicle controller to:
receive, from a sensor subsystem located in the autonomous vehicle, a vehicle speed measurement; and
determine the first speed-dependent threshold and the second speed-dependent threshold based on the vehicle speed measurement.

7. The in-vehicle controller of claim 1, wherein the executable code is further configured to cause the in-vehicle controller to:
receive, from a sensor subsystem located in the autonomous vehicle, the current vehicle steering angle.

8. The in-vehicle controller of claim 1, wherein the executable code is further configured to cause the in-vehicle controller to:
determine a regression fit for a plurality of steering angles indicating by the steering command and the one or more preceding steering commands; and
use a derivative of the regression fit as the rate of change for evaluating the steering command against the second speed-dependent threshold.

9. The in-vehicle controller of claim 1, wherein the executable code is further configured to cause the in-vehicle controller to:
determining a number of frames in a predetermined time window in which the steering command fails to satisfy the second speed-dependent threshold; and
based on the number of frames exceeding a particular percentage of the predetermined time window, trigger an emergency maneuver for the autonomous vehicle.

10. A method for monitoring steering operation of a vehicle, comprising:
receiving, by an in-vehicle controller from a remote server, a steering command that indicates a steering angle for navigation of the vehicle;
evaluating, by the in-vehicle controller, the steering command against at least two speed-dependent thresholds, the at least two speed-dependent thresholds comprising a first speed-dependent threshold with respect to a difference between the steering angle and a current vehicle steering angle and a second speed-dependent threshold with respect to a rate of change of the steering angle with one or more preceding steering commands;
determining, by the in-vehicle controller, whether the steering command is valid or not based on weighing, according to a current operation mode of the vehicle, respective flags resulting from the at least two speed-dependent thresholds; and
in accordance with the current operation mode being a manual operation mode and a determination that the steering command is not valid, transmitting, by the in-vehicle controller, instructions to an in-vehicle user interface to cause the in-vehicle user interface to disable engagement of an autonomous operation mode for the vehicle via the in-vehicle user interface.

11. The method of claim 10, further comprising:
evaluating, by the in-vehicle controller, a second steering command against the at least two speed-dependent thresholds; and
in accordance with (i) the current operation mode being an autonomous operation mode and (ii) a determination that the second steering command is not valid based on the evaluating, triggering, by the in-vehicle controller, a maneuver for the vehicle to reach a complete stop.

12. The method of claim 11, wherein the maneuver includes locally-determined steering angles determined by the in-vehicle controller in accordance with a third speed-dependent threshold associated with the maneuver.

13. The method of claim 10, further comprising:
evaluating, by the in-vehicle controller, a second steering command against the at least two speed-dependent thresholds; and
in accordance with (i) the current operation mode being an autonomous operation mode and (ii) a determination that the steering command is valid, applying, by the in-vehicle controller, the second steering command by controlling a steering subsystem of the vehicle.

14. The method of claim 10, further comprising:
receiving, by the in-vehicle controller from a sensor subsystem located in the vehicle, a vehicle speed measurement; and
determining, by the in-vehicle controller, the first speed-dependent threshold and the second speed-dependent threshold based on the vehicle speed measurement.

15. The method of claim 10, further comprising:
receiving, by the in-vehicle controller from a sensor subsystem located in the vehicle, the current vehicle steering angle.

16. The method of claim 10, further comprising:
determining, by the in-vehicle controller, a regression fit for a plurality of steering angles indicating by the steering command and the one or more preceding steering commands; and
evaluating, by the in-vehicle controller, the steering command against the second speed-dependent threshold using a derivative of the regression fit as the rate of change.

17. The method of claim 10, further comprising:
determining a number of frames in a predetermined time window in which the steering command fails to satisfy the second speed-dependent threshold; and
based on the number of frames exceeding a particular percentage of the predetermined time window, trigger an emergency maneuver for the vehicle.

18. A non-transitory computer-readable program storage medium having code stored thereon, the code, when executed by a processor, causing the processor to implement a method comprising:
receiving, from a remote server, a steering command that indicates a steering angle for navigation of an autonomous vehicle;
evaluating the steering command against at least two speed-dependent thresholds, the at least two speed-dependent thresholds comprising a first speed-dependent threshold with respect to a difference between the steering angle and a current vehicle steering angle and a second speed-dependent threshold with respect to a rate of change of the steering angle with one or more preceding steering commands;
determining whether the steering command is valid or not based on weighing, according to a current operation mode of the vehicle, respective flags resulting from the at least two speed-dependent thresholds; and
in accordance with the current operation mode being a manual operation mode and a determination that the steering command is not valid, transmitting instructions to an in-vehicle user interface to cause the in-vehicle user interface to disable engagement of an autonomous operation mode for the vehicle via the in-vehicle user interface.

19. The non-transitory computer-readable program storage medium of claim 18, wherein the method further comprises:
determining a regression fit for a plurality of steering angles indicating by the steering command and the one or more preceding steering commands; and
evaluating the steering command against the second speed-dependent threshold using a derivative of the regression fit as the rate of change.

20. The non-transitory computer-readable program storage medium of claim 18, wherein the method further comprises:
determining a number of frames in a predetermined time window in which the steering command fails to satisfy the second speed-dependent threshold; and
based on the number of frames exceeding a particular percentage of the predetermined time window, trigger an emergency maneuver for the autonomous vehicle.
